(19) United States
(12) Patent Application Publication
(10) Pub. No.: US 2006/0061014 A1
(43) Pub. Date: Mar. 23, 2006

(54) Injection molding of highly filled resins

(76) Inventors: Paul Edward Beauchemin, West Seneca, NY (US); William Daniel Saunders, Delaware City, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/943,314

(22) Filed: Sep. 17, 2004

(51) Int. Cl. B29C 45/00

(52) U.S. Cl. 264/328.17; 264/328.18

(57) ABSTRACT

A process is disclosed for injection-molding of a thermoplastic resin highly filled with a hydrated mineral filler wherein a lubricant is introduced to permit the composition to be molded at a temperature with minimum or no degradation of the filler due to a release of water.

### BACKGROUND OF THE INVENTION

1. Field of the Invention

This invention relates to a process for producing solid surface parts by an injection-molding process in which an improved composition is used to allow molding of resin material highly filled with hydrated mineral.

2. Description of the Related Art

Heitner and Hutchins in U.S. Pat. No. 6,554,451 disclose a method for extrusion of an acrylic material highly filled with aluminum trihydroxide wherein a lubricant is introduced to permit the composition to be extruded without degradation of ingredients. The lubricant is compounded with the resin and filler in the interconnected mixing zones of an extruder before passing a resulting mixture through a die. Pellets formed by this process have been found to present problems for injection-molding as a melt temperature in the molding machine rises above 200° C. Such an elevated temperature may cause foaming and degradation of the composition despite the presence of lubricant in the pellets.

There is a need for an improved injection-molding process wherein foaming and degradation of employed pellets does not occur.

### SUMMARY OF THE INVENTION

The present invention is directed to a process for producing an injection-molded solid surface part from highly filled resin comprising coating pellets of a resin containing hydrated mineral filler with a lubricant, introducing said pellets into an injection-molding machine and molding a part from the coated pellets.

A further embodiment of the invention is directed to a process for producing an injection-molded solid surface part from highly filled resin comprising introducing pellets of a resin containing hydrated mineral filler into an injection-molding machine, said injection-molding machine having a feedscrew with a feed throat, introducing a lubricant via a pump in said feed throat of the molding machine feedscrew, and molding a part from the pellets and lubricant.

### DETAILED DESCRIPTION OF THE PREFERRED EMBODIMENTS

The process of the present invention is directed to overcoming decomposition of a hydrated mineral filler in injection-molding pellets of a thermoplastic resin composition containing hydrated mineral filler. As employed herein decomposition means separation of water from the hydrated mineral filler. It has been found that decomposition of the filler typically occurs at temperatures above about 200° C. In the present invention a lower molding temperature can be employed to avoid or minimize such decomposition.

A highly filled resin composition denotes that resin is present in an amount of 38 to 80% by weight of the total composition and hydrated mineral filler is present in an amount of 20 to 62% by weight of the total composition. A preferred weight of hydrated mineral filler is 40 to 60% by weight (and accordingly 40 to 60% by weight resin).

As employed herein, resin is used in its normal meaning, provided the resin is thermoplastic and includes polymeric containing materials and chemically modified natural resin. Preferred thermoplastic resins include polymers of polyacetal, polyacrylonitrile, polybutadiene, polystyrene, polycarbonate, polyacrylate and polyethylene and copolymers thereof. A preferred polymer is polyacrylate with a specific example being polymethylmethacrylate (PMMA).

The mineral filler employed with the thermoplastic resin is water bearing such as containing water molecules bound in a crystal structure. It is considered that the water contained with the mineral filler causes defects in injection-molding resin due to a need for a high molding temperature when a large amount of mineral is present. Examples of mineral fillers which include water are aluminum trihydroxide, calcium carbonate, zinc sulfate and mixtures thereof.

To avoid a need for a high injection-molding temperature the process of the present invention employs a lubricant thereby overcoming the tendency to create excessively high temperatures (and pressures) in the molding process. The lubricant is either precoated on the pellets of hydrated mineral filled resin or added to the pellets via a pump in a feed throat of an injection-molding machine wherein the lubricant is present in interstices between individual pellets during the molding process.

As employed herein a lubricant is a material which has a lower coefficient of friction in comparison to a resin with the hydrated mineral filler and is flowable under the temperatures and pressures of the injection-molding process. A typical concentration of lubricant is at least 1%, such as 1 to 5%, by weight of the total weight of the final molded solid surface part. Optionally, the lubricant can be used at higher concentrations which is considered to provide a lower viscosity to the molding composition and a lower molding temperature. However, a disadvantage may result in some instances due to decreased surface appearance of the molded part.

It has been found that to improve the surface appearance of the molded part that a lubricant can be employed which is a polymerizable monomer. In such case the monomer is employed with an initiator which serves to polymerize the monomer during the molding process.

A particularly preferred thermoplastic resin for use in the present invention is an acrylic resin such as poly(methylmethacrylate) (PMMA). A preferred hydrated mineral filler for this resin is aluminum trihydroxide (generally known in the art as ATH).

A lubricant for a preferred polymethylmethacrylate/hydrated aluminum trihydroxide material is a polymerizable monomer which forms a polymer during the molding process when employed with an initiator. Examples of monomers include acrylates such as methyl acrylate, ethyl acrylate, i-propyl acrylate, n-propyl acrylate, n-butyl acrylate, i-butyl acrylate, and lauryl acrylate. Fatty acid esters such as stearyl acrylate may be used. A preferred polymerizable monomer is 2-ethylhexylacrylate since the monomer can polymerize at about the same temperature of the polymethylmethacrylate. A preferred initiator is a peroxy initiator such as 2,5-dimethyl-2-5-di(t-butylperoxy)hexane.

In addition to the resin, hydrated mineral filler and lubricant discussed above, additives such as pigments, dyes, rubbers, flame retardants, antioxidants and the like as known to those skilled in the art may be added in the molding composition.

The following examples, in which parts and percentages are by weight unless otherwise indicated, further illustrate the invention.

### EXAMPLES

### Example 1

The following composition was pelletized:
50% ATH
47% PMMA
3% EHA monomer (98:2 EHA:peroxide)

After pelletizing the above, the resulting pellets were coated with the lubricant comprised of EHA monomer and peroxide initiator (98:2 EHA:peroxide) prior to addition to the injection-molding machine. The pellets were coated at 4% based on the combined weight of pellets and coated lubricant, and subsequently introduced into an injection-molding machine. The temperature of the injection-molding machine remained below 190° C., the material completely filled the mold and the parts were solid, i.e. not foamy.

### Comparative Examples

### Comparative Example 1

A composition of the following was pelletized:
50% ATH
47% PMMA
3% EHA monomer (98:2 EHA:peroxide)

An attempt was made to injection-mold this composition. A wide range of mold temperatures, injection velocities and fill pressures were tried. Machine temperatures exceeded 215° C., the mold did not fill and the part was foamy.

### Comparative Example 2

A composition of the following was pelletized:
50% ATH
44% PMMA
6% EHA monomer (98:2 EHA:peroxide)

An attempt was made to injection-mold this composition. A wide range of mold temperatures, injection velocities and fill pressures were tried. Machine temperatures exceeded 215° C., the mold did not fill and the part was foamy.

What is claimed is:

1. A process for producing an injection-molded part from a highly filled thermoplastic resin comprising:
(a) coating pellets comprised of 38 to 80% thermoplastic resin and 20 to 62% hydrated mineral filler based on the weight of the total pellet composition with a lubricant,
(b) introducing said pellets into an injection-molding machine, and
(c) molding a part with the resulting mixture.

2. The process of claim 1 wherein the resin contains polymer selected from the group consisting of polyacetal, polyacrylonitrile, polybutadiene, poly styrene, polycarbonate and polyacrylate and copolymers thereof.

3. The process of claim 1 wherein the hydrated mineral filler is selected from hydrated aluminum trihydroxide, hydrated calcium sulfate, hydrated zinc borate and mixtures thereof.

4. The process of claim 1 wherein the resin comprises polymethylmethacrylate and the hydrated mineral filler comprises hydrated aluminum trihydroxide.

5. The process of claim 4 wherein said lubricant comprises a polymerizable monomer and an initiator.

6. The process of claim 5 wherein the polymerizable monomer is 2-ethylhexylacrylate.

7. The process of claim 1 wherein a temperature not greater than 200° C. is employed.

8. The process of claim 1 wherein lubricant is present in the pellets prior to step (a).

9. An injection-molded part made from the process of claim 1.

10. A process for producing an injection-molded part from highly filled thermoplastic resin in an injection-molding machine having a feedscrew with a feed throat comprising
(a) introducing pellets comprised of 38 to 80% thermoplastic resin and 20 to 62% hydrated mineral filler based on weight of the total pellet composition into the injection-molding machine,
(b) introducing a lubricant via a pump in said feed throat of the molding machine feedscrew,
(c) introducing the lubricant in interstices between the pellets, and
(d) molding a part.

11. The process of claim 8 wherein the resin is selected from group consisting of polyacetal, polyacrylonitrile, polybutadiene, polystyrene, polycarbonate, polyacrylate and copolymers thereof.

12. The process of claim 8 wherein the resin is polymethylmethacrylate and the hydrated mineral filler is hydrated aluminum trihydroxide.

13. The process of claim 8 wherein lubricant is present in the pellets prior to step (a).

14. An injection-molded part made from the process of claim 8.
